(19) United States
(12) Patent Application Publication
(10) Pub. No.: US 2026/0218820 A1
(43) Pub. Date: Jul. 30, 2026

(54) CYLINDRICAL TUBULAR ELEMENT COMPRISING A FRUSTO-CONICALLY SHAPED PRESS FIT CONNECTION

(71) Applicant: METAZET FORMFLEX HOLDING B.V., Wateringen (NL)

(72) Inventor: Lucas Gerardus VAN ADRICHEM, Wateringen (NL)

(73) Assignee: METAZET FORMFLEX HOLDING B.V., Wateringen (NL)

(21) Appl. No.: 19/146,020

(22) PCT Filed: Jan. 5, 2024
(86) PCT No.: PCT/NL2024/050005

§ 371 Date: Jul. 7, 2025

(30) Foreign Application Priority Data
Jan. 11, 2023 (NL) 2033949
Jun. 29, 2023 (NL) 2035221

(51) Int. Cl. F16L 13/14; A01G 9/14; A01G 9/24; B21D 39/04

(52) U.S. Cl. CPC F16L 13/14; A01G 9/143; A01G 9/245; B21D 39/04; F16L 2013/145

(57) ABSTRACT

System of tubular elements for use in a temperature control and/or transport system of a horticulture field or greenhouse (1000) that comprises a plurality of spaced apart and parallel arranged longitudinal linear tubes (100), wherein the system comprises at least two interconnected tubular elements (100), wherein said first tubular element (100) is connected at a first end section (110) of the first longitudinal tubular element (100) to the second tubular element (200) at a second end section (230) of the second tubular element (200); wherein the respective first end section (110) of the first tubular element (100) is a frusto-conically shaped end section, wherein, as seen along a longitudinal axis of the first end section (110), an outer diameter (d0) of the frusto-conically shaped end section decreases towards the first outer end (111) of the first tubular element (100); wherein the respective second (200) end section of the second (200) tubular element (100) is an inverted inner frusto-conically shaped end section, wherein, as seen along a longitudinal axis of the respective second (200) end section, an inner diameter of the frusto-conically shaped end section increases towards the second outer end (131) of the second tubular element (200); wherein said inverted inner frusto-conically shaped end section (230) of said second tubular element (200) is arranged to receive the frusto-conically shaped end section of the first tubular element (100) for forming a connection section, such that the first (100) and second (200) tubular elements are mechanically interconnected at the connection section by insertion of the frusto-conically shaped end section of a first tubular element (100) into the inverted inner frusto-conically shaped end section of the second tubular element (200).

The present invention relates to a tubular element comprising a frusto-conically shaped press fit connection, a system of tubular elements for use in a temperature control and/or transport system of a horticulture field or greenhouse that comprises a plurality of spaced apart and parallel arranged longitudinal linear tubes, a method of manufacturing said linear tube assembly, a temperature control and/or transport system for use in a horticulture field or greenhouse comprising the a system of tubular elements and a horticulture greenhouse comprising the temperature control and/or transport system.

In many horticulture greenhouses the horticulture crops are often arranged in consecutive pairs of rows of plants, wherein between a pair of plants a pair of parallel arranged longitudinal linear tubes is arranged that are part of a system of tubular elements of a temperature control and/or transport system. Said pair of tubes can be arranged close to (but spaced apart from), and supported on, the ground, such that it can function as a transport rail for supporting al types of rail-supported vehicles that are used during cultivating and/or harvesting. Alternatively, or additionally, the tubes can be supported in an upper region of the greenhouse to function as a rail from a monorail based transport system and/or heat transfer element.

Such a system of tubular elements comprising these parallel arranged longitudinal linear tubes are often also arranged for guiding a flow of liquid therethrough and by connecting said tubes to a heating and/or cooling system for providing a flow of heating or cooling liquid, the parallel arranged longitudinal linear tubes are acting as a heat exchanger of the temperature control system for controlling a temperature in the horticulture greenhouse.

These parallel arranged longitudinal linear tubes typically span from a central pathway of the horticulture greenhouse to its outer walls, or between two, separate, central pathways and can be several tens of meters, or even over a hundred meters long. The parallel arranged longitudinal linear tubes are typically arranged and positioned during construction (or renovation) of said greenhouse. Thereto, temporary racks are arranged on the vertical pillars supporting a roof section of the greenhouse whereon pre-produced tubular members, which are typically around 6 m to 10 m long, are positioned such that a plurality of pre-produced tubular members are arranged aligned along their longitudinal axis to abut each other at the respective ends of the pre-produced tubular members. The pre-produced tubular members are then connected together for forming a single long longitudinal linear tube by means of welding. The welding of the pre-produced tubular members is done (in situ) manually by an experienced welder as the welds need to be liquid tight in order to prevent leakage of the long longitudinal linear tubes when they are used as heat exchangers.

As the welding process is done manually, this requires a lot of man hours to complete. A lack of experienced welders can thereby significantly delay the construction (or renovation) period of the horticulture greenhouse. Even more so as the pre-produced tubular elements and/or the welded together long longitudinal linear tubes that are arranged on the temporary racks, span over almost the full width or length of the greenhouse, such that this poses a significant obstruction to other works that need to be done, or for larger pieces of machinery that are required for those works.

Scheduling the welding step at a later stage during construction and/or renovation is often not possible, as at this stage flammable plastic foils are arranged on the ground of the greenhouse and/or flammable plastic screens are installed underneath the roof of the greenhouse, such that welding at this stage would lead to an unallowable risk of fire.

The present invention therefore aims to provide for a system of tubular elements for use in a temperature control and/or transport system of a horticulture field or greenhouse that comprises a plurality of spaced apart and parallel arranged longitudinal linear tubes that at least alleviates some the above presented problems, and in particular can be assembled at a later stage in the construction (or renovation) period of the horticulture greenhouse, that reduces and/or prevents the risk of fire. Even more so, the present invention aims to provide for such tubes without requiring any welding.

In a first aspect, the invention relates to a system of tubular elements for use in a temperature control and/or transport system of a horticulture field or greenhouse that comprises a plurality of spaced apart and parallel arranged longitudinal linear tubes, wherein the system comprises at least two interconnected preferably cylindrical, tubular elements,
wherein said first tubular element is connected at a first end section of the first longitudinal tubular element to the second tubular element at a second end section of the second tubular element;
wherein the respective first end section of the first tubular element is a frusto-conically shaped end section, wherein, as seen along a longitudinal axis of the first end section, an outer diameter of the frusto-conically shaped end section decreases towards the first outer end of the first tubular element;
wherein the respective second end section of the second tubular element is an inverted inner frusto-conically shaped end section, wherein, as seen along a longitudinal axis of the respective second end section, an inner diameter of the frusto-conically shaped end section increases towards the second outer end of the second tubular element;
wherein said inverted inner frusto-conically shaped end section of said second tubular element is arranged to receive the frusto-conically shaped end section of the first tubular element for forming a connection section, such that the first and second tubular elements are mechanically interconnected at the connection section by insertion of the frusto-conically shaped end section of a first tubular element into the inverted inner frusto-conically shaped end section of the second tubular element.

Said frusto-conically shaped end section and inverted inner frusto-conically shaped end section thereby allow to obtain a structural (i.e. load bearing) connection by inserting, and preferably pressing, said frusto-conically shaped end section into inverted inner frusto-conically shaped end section that remains intact while loading the parallel arranged longitudinal linear tubes in a direction perpendicular to the longitudinal axis, for instance by means of a trolley that is movably supported on top of said parallel arranged longitudinal linear tubes, and that allows for pressurized (at relatively low pressures of 1-5 bars) heating and/or cooling liquid to flow through said parallel arranged longitudinal linear tubes. The connection is thereby made without welding, such that there is also no need for experienced welders. Also, as the risk of fire is low, or even non-existent, the parallel arranged longitudinal linear tubes can be made at a later stage in the construction (or renovating) process of the horticulture greenhouse, such that the other works are not obstructed by this process and the construction (or renovating) process can be completed in less lead time.

Therefore, it is preferred that at least one longitudinal linear tube of the plurality of spaced apart and parallel arranged longitudinal linear tubes comprises said respective first and second tubular elements, wherein said first and second tubular elements are longitudinal tubular elements having a respective central longitudinal axes that coincided and align with the respective longitudinal axes of the respective end sections, such that the respective central longitudinal axes of the first and second tubular elements align and coincide for, at least partly, forming said at least one longitudinal linear tube.

Preferably, at least one first or second tubular element is a tubular coupling element, wherein said tubular coupling element interconnects at least two spaced apart longitudinal linear tubes of the plurality of spaced apart longitudinal linear tubes, wherein said tubular coupling element comprises at least an intermediate tubular section, that is arranged in between the first and second end sections, having a tangential thereto, wherein said tangential is at a non-zero angle with respect to the longitudinal axes of the respective first or second end section. A pair of longitudinal linear tubes are often interconnected its end, such that, when used for guiding a flow of heating/cooling liquid, through a first tube of said pair the flow is moved in a first direction and through the second tube of said pair, the flow is moved in the opposite direction, thereby requiring only feed-lines at one end of said pair. By arranging a tubular coupling element between said tubes of the pair, no welding is also required for the interconnection, thereby further reducing any disadvantages and/or risks associated to welding as described above.

It is therefore also preferred that said system of assembled tubular elements is arranged for guiding a flow of heating and/or cooling liquid therethrough and is arranged as a heat transfer element for transferring energy from the heating and/or cooling liquid to an internal environment of said horticulture greenhouse and/or vice versa; and wherein, preferably, said connection section forms a liquid-tight connection. This reduced the need for applying separate solutions for making a liquid-tight connection, such that said longitudinal linear tube assembly is directly suitable to be used as the heat exchanging element in the temperature control system of the greenhouse.

Preferably, means for sealing said connection, such a, preferably liquid, gasket or adhesive is arranged in between said frusto-conically shaped end section and inverted inner frusto-conically shaped end section. This can, for instance, applied to at least one of said frusto-conically shaped end section and inverted inner frusto-conically shaped end section before insertion of the frusto-conically shaped end section into the inverted inner frusto-conically shaped end section. Due to the process of producing said frusto-conically shaped end section and/or inverted inner frusto-conically shaped end section, surface and/or shape imperfections can occur that could negatively affect the liquid-tightness of connection. By arranging said gasket or adhesive in between the frusto-conically shaped end section and inverted inner frusto-conically shaped end section, these imperfections can be taken up by the gasket, such that still a liquid-tight connection can be obtained.

The gasket is preferably seated in a groove provided circumferentially in the outer or inner surface of respectively the frusto-conically shaped end section or inverted inner frusto-conically shaped end section. Additionally, or alternatively, the gasket is preferably an O-ring. By seating the O-ring in the groove, the O-ring can be effectively kept in place in spite of the end section being frustoconical, to further enhance said liquid-tightness.

Preferably, at least one longitudinal linear tube of the plurality of spaced apart and parallel arranged longitudinal linear tubes forms part of a rail system of the respective transport system for supporting a rolling vehicle, such as a trolley. In a further preferred embodiment, said the at least one longitudinal linear tube of the plurality of spaced apart and parallel arranged longitudinal linear tubes is suspended in the greenhouse and arranged for supporting a monorail-vehicle that can suspended from, and arranged underneath, the at least one longitudinal linear tube, such that said monorail-vehicle is movable along the at least one longitudinal linear tube. As an alternative, said rail system of the respective transport system comprises two spaced apart longitudinal linear tubes of the plurality of spaced apart and parallel arranged longitudinal linear tubes that are supported at a predefined height with respect to a ground surface, such that a rail-vehicle can be movable supported by the two spaced apart longitudinal linear tubes. This enables to use all types of suitable trolleys used for cultivating and/or harvesting of the crops in the horticulture field or greenhouse, during its use.

In a preferred embodiment, the outer diameter is, at the start of the frusto-conically shaped end section (i.e. at the end of the frusto-conically shaped end section closest to the central section of the cylindrical tubular element), the outer diameter is reduced such that a maximum outer diameter of the frusto-conically shaped end section is smaller than the outer diameter of a central section of the cylindrical tubular element, wherein said central section is in between the first end section and an opposite second end section of the tubular elements. This allows to reduce the length of any discontinuities in the outer diameter of the longitudinal linear tube, as the outer end second tubular element can be brought closer to the central section of the first tubular element having a, preferably, constant outer diameter. The smaller the discontinuities in the outer diameter of the linear tube assembly, the smoother (i.e. the less bumpy) a trolley can move over the longitudinal linear tube.

Preferably, an outer diameter of the inverted inner frusto-conically shaped end section is substantially equal to the outer diameter of the central section of the second tubular element. This also enables to reduce any discontinuities in the outer diameter of the longitudinal linear tube, as explained above. Hence, it is preferred that the at least one longitudinal linear tube of the plurality of spaced apart and parallel arranged longitudinal linear tubes has a substantially constant outer diameter over substantially the full length of the respective longitudinal linear tube.

In a preferred embodiment, said first tubular element comprises, at a second end section that is arranged at the opposite end of the first tubular element, an inverted inner frusto-conically shaped end section, wherein, as seen along a longitudinal axis second end section of the first tubular element, an inner diameter of the frusto-conically shaped end section increases towards the second outer end of the first longitudinal tubular element; and/or
wherein said second tubular element comprises, at a first end section that is arranged at the opposite end of the second tubular element, a frusto-conically shaped end section, wherein, as seen along a longitudinal axis a the first end section of the second tubular element, an outer diameter of the frusto-conically shaped end section decreased towards the first outer end of the second tubular element; and
preferably wherein said first and second tubular elements are substantially identical tubular elements.

Hereby a full length of the longitudinal linear tube can be obtained by connecting identical longitudinal tubular elements. This significantly simplifies the supply and handling of these elements and eliminate the need for any welding and its associated problems.

Preferably, said frusto-conically shaped end section has a substantially smooth outer surface and/or said inverted inner frusto-conically shaped end section has a substantially smooth inner surface. Such a substantially smooth surface may, however, comprise some production imperfections, such as a, ore multiple, longitudinally extending grooves that originate from the use of clamping tools in a mechanical tube reducing process. A smooth surface is defined as a surface free of treading, ridges, ripples and/or any other recesses and/or protrusions that are all specifically configured for interlocking into corresponding protrusions and/or recesses arranged in the opposing surface of the set of surfaces that abut in the connected state. Such a smooth surface allows for a simple press fitting connection, wherein any imperfection can be addressed using a (liquid) gasket or adhesive as was described above.

The gasket may be seated in a groove as described above. The groove is not specifically configured for interlocking with a corresponding protrusion arranged in the opposing surface, such that also a surface provided with the groove can allow for a particularly simple press fitting connection if this surface is substantially smooth as defined above.

In a preferred embodiment, said tubular elements are mechanically interconnected by a slip-critical joint, wherein at least part of an outer surface of the frusto-conically shaped end section and at least part of an inner surface of the inverted inner frusto-conically shaped end section are arranged as faying surfaces that abut each other, and
wherein said faying surfaces are abutting and coupled to each other through friction after pressing said frusto-conically shaped end section into said inverted inner frusto-conically shaped end section with a predetermined pressing force upon interconnecting said tubular elements. This allows to couple the respective tubular elements by press fitting, preferably with a predefined minimum and/or maximum pressing force, the frusto-conically shaped end section into the inverted inner frusto-conically shaped end section. Such an operation can be performed relatively easy in situ, such that the spaced apart and parallel arranged longitudinal linear tubes can be assembled at, or near, the final location where they are to be positioned, while avoiding specialist labor, such as welding.

In a preferred embodiment, the outer diameter of the frusto-conically shaped end section continuously decreases towards the first outer end of the first longitudinal tubular element; and/or
wherein the inner diameter of the frusto-conically shaped end section continuously increases towards the second outer end of the second longitudinal tubular element.

The continuously decreasing outer, or continuously increasing inner, diameter can be machined in a relatively simple manner, while being suitable for obtaining a reliable connection that does not require specialist labor.

Preferably, the outer diameter of the frusto-conically shaped end section comprises decreases with an angle of 0.01 degrees-5 degrees, preferably 0.1 degrees-2.5 degrees, more preferably 0.25 degrees-1 degree, most preferably about 0.7 degrees; and/or
wherein the inner diameter of the inverted inner frusto-conically shaped end section increases with angle of 0.01 degrees-5 degrees, preferably 0.1 degrees-2.5 degrees, more preferably 0.25 degrees-1.5 degree, most preferably 0.5-1 degrees; and/or
wherein a ratio between the angle of decrease of the frusto-conically shaped end section and the angle of increase of the inverted inner frusto-conically shaped end section is between 0.5 and 2, preferably between 0.75 and 1.5, more preferably between 0.9 and 1.1 and most preferably around 1.

A good clamping force, and thereby friction force, between the respective tubular elements is thereby obtainable. The tubular elements therefore do not need additional manners of fastening them to each other.

In particular if the tubular elements are to be used for guiding a flow of heating/cooling liquid therethrough and/or for supporting a vehicle, an adhesive such as glue may be applied between the end sections in the connection section. Since the connection section is formed by the frustoconical end sections, a large adhesive surface can be provided for creating a strong glue connection. However, the glue might not yet have fully dried when the interconnected tubular elements are to be brought onto the horticulture field or into the greenhouse. It may therefore be preferred if said ratio between the angle of decrease of the frustoconical end section and the angle of increase of the inverted inner frustoconical end section is slightly below 1, which would result in a tight friction fit of the frustoconical end section into the inverted inner frustoconical end section such that, when pressing the frustoconical end section into the inverted inner frustoconical end section, an initial connection strength can be obtained that allows the interconnected tubular elements to be conveniently transported, after which the final connection strength can be obtained after the glue has dried.

It is preferred that the length of the frusto-conically shaped end section is in the range of 0.25-3 times, preferably in the range of at least 0.35 times-2 times, more preferably in the range of 0.5-1.5 times, an outer diameter of the first tubular element; and/or
wherein a length of the inverted inner frusto-conically shaped end section is in the range of 0.25-3 times, preferably in the range of at least 0.35 times-2 times, more preferably in the range of 0.5-1.5 times, an outer diameter of the first tubular element; and/or
wherein a ratio between the length of the frusto-conically shaped end section and the length of the inverted inner frusto-conically shaped end section is between 0.5 and 2, preferably between 0.75 and 1.5, more preferably between 0.9 and 1.1 and most preferably around 1.

A relative large contact surface, and thereby a reliable friction based connection, between the respective tubular elements is thereby obtainable. The tubular elements therefore do not need additional manners of fastening them to each other.

In a preferred embodiment, wherein said first and second tubular elements are metal tubes, in particular steel tubes, and/or
wherein said first and second tubular elements have an outer diameter of 20-100 mm, preferably of 35-70 mm, more preferably of 38 mm or 51 mm, and/or,
wherein said first and second tubular elements are longitudinal tubular elements having a length of 0.5-20 m, preferably 1 m-10 m, more preferably 2 m-8 m, most preferably 4 m-6 m.

As tubular elements having these dimensions are typically used in horticulture fields or greenhouses, sufficient supply is available. In addition, existing tools, machinery and auxiliary components can be used for the process, such that it is easily integrated into the existing workflows for greenhouse construction and/or renovation.

In a second aspect, the invention relates to a temperature control and/or transport system for use in a horticulture field or greenhouse comprising a system of tubular elements according to any of the preceding embodiments. The above identified advantages can thereby be obtained.

In a third aspect, the invention relates to a tubular element for use in a system of tubular elements according to any of the preceding embodiments and/or a temperature control and/or transport system according to any of the preceding embodiments, wherein the, preferably cylindrical, tubular element comprises a first end section and an opposite second end section;
wherein said first end section is a frusto-conically shaped end section, wherein, as seen along a longitudinal axis of the first end section, an outer diameter of the frusto-conically shaped end section decreases towards the first outer end of the tubular element or wherein said first end section is an inverted inner frusto-conically shaped end section, wherein, as seen along the longitudinal axis of first end section, an inner diameter of the frusto-conically shaped end section increases towards the first outer end section of the tubular element; and/or
wherein said opposite second end is an inverted inner frusto-conically shaped end section, wherein, as seen along the longitudinal axis of the tubular element, an inner diameter of the frusto-conically shaped end section increases towards the second outer end of the tubular element or wherein said opposite second end is a frusto-conically shaped end section, wherein, as seen along a longitudinal axis of the second end section, an outer diameter of the frusto-conically shaped end section decreases towards the second outer end of the tubular element;
wherein, preferably, an outer diameter of the inverted inner frusto-conically shaped end section is substantially equal to the outer diameter of the central section of the, preferably cylindrical, tubular element;

In a preferred embodiment, said, preferably cylindrical, tubular element is a longitudinal cylindrical tubular element, wherein the first end section is the frusto-conically shaped end section and wherein the opposite second end is the inverted inner frusto-conically shaped end section; wherein said inverted inner frusto-conically shaped end section is arranged to receive the frusto-conically shaped end section, such that a plurality of equally shaped longitudinal, preferably cylindrical, tubular elements can be mechanically interconnected by inserting a frusto-conically shaped end section of a first tubular element into an inverted inner frusto-conically shaped end section of a second tubular element of said plurality of equally shaped longitudinal, preferably cylindrical, tubular elements. This enables to obtain the above described advantages.

In an alternative preferred embodiment, said, preferably cylindrical, tubular element is a tubular coupling element, wherein said tubular coupling element is arranged to interconnect at least two spaced apart longitudinal linear tubes of the plurality of spaced apart longitudinal linear tubes as used in the system of tubular elements according to any of the previous embodiments thereof, wherein said tubular coupling element comprises at least an intermediate tubular section, that is arranged between the first and second end sections, having a tangential thereto, wherein said tangential is at a non-zero angle with respect to the longitudinal axes of the respective first or second end section; and wherein said first and second end sections are both frusto-conically shaped end sections or are both inverted inner frusto-conically shaped end sections. As a pair of longitudinal linear tubes will typically be arranged in the same order, i.e. both starting or ending with a frusto-conically shaped end sections or an inverted inner frusto-conically shaped end sections, the tubular coupling element can easily connect to both ends by having the same shape end section at both its ends. For this, it is preferred that the tubular coupling element is a substantially U shaped tubular element, wherein the first and second end sections form the respective legs of the U, and preferably a curved (e.g. semi-circular), or perpendicular (i.e. perpendicular to the respective end sections) intermediate tubular section is arranged in between the respective legs of the U for forming the bottom section of said U.

In a fourth aspect, the invention relates to a longitudinal linear tube as used in the system of assembled tubular elements according to any of the above described embodiments, comprising the respective interconnected first and second tubular elements, wherein said first and second tubular elements are longitudinal tubular elements having a respective central longitudinal axes that coincided and align with the respective longitudinal axes of the respective end sections, such that the respective central longitudinal axes of the first and second tubular elements align and coincide. The longitudinal cylindrical tubular element, and the use thereof in a longitudinal linear tube, lead to the above described advantages.

In a fifth aspect, the invention relates to a method of manufacturing system of assembled tubular elements according to any of the preceding embodiments, comprising the steps of:
providing a first, preferably cylindrical, tubular element having a respective first end section that is a frusto-conically shaped end section, wherein, as seen along the longitudinal axis of the first end section of the first tubular element, an outer diameter of the frusto-conically shaped end section decreases towards the first outer end of the first tubular element;
providing a second, preferably cylindrical, tubular element having a respective second end section that is an inverted inner frusto-conically shaped end section, wherein, as seen along the longitudinal axis of the second end section of said second tubular element, an inner diameter of the frusto-conically shaped end section increases towards the second outer end of the second tubular element;
aligning said first and second tubular elements such that respective longitudinal axes of the respective first and second end sections element align and coincide and such that the respective first end section of the first tubular element faces the respective second end section of the second tubular element;
inserting the frusto-conically shaped end section of the first tubular element into the inverted inner frusto-conically shaped end section of the second tubular element;
pressing said frusto-conically shaped end section into said inverted inner frusto-conically shaped end section by pressing said first and second tubular elements towards each other along the respective longitudinal axes with a predefined pressing force, such that the frusto-conically shaped end section of the first cylindrical tubular element is forced into the inverted inner frusto-conically shaped end section of the second tubular element for mechanically interconnection said tubular elements.

Hereby, the longitudinal linear tube and its associated benefits can be obtained. In addition, the method can be executed in situ without the need for specialist skills, such as welding. Also, assembly of the plurality of spaced apart and parallel arranged longitudinal linear tubes for use in a temperature control and/or transport system of a horticulture greenhouse can be performed after ground plastic and screens are installed in the greenhouse without the potential fire risks of, for instance, welding.

In a preferred embodiment of the method, the step of providing the first tubular element comprises the steps of:
providing a cylindrical tubular element having a substantially constant outer diameter;
forming, at the first end of the cylindrical tubular element, the frusto-conically shaped end section by applying a tube end reduction process;
   and/or wherein the step of providing the second tubular element comprises the steps of:
providing a cylindrical tubular element having a substantially constant outer diameter; —forming, at the second end of the cylindrical tubular element, the inverted inner frusto-conically shaped end section by applying an inner tube reaming process.

The respective ends can be formed in situ, i.e. just before assembling said (longitudinal) tubular elements. In that case one can supply a series of standard off-the-shelf tubular elements, for instance, according to the dimensions specified, and machine these on site. Alternatively, this step can be performed at a dedicated production facility, whereafter the, preferably longitudinal, tubular elements are shipped to the installation site, i.e. the horticulture greenhouse, where they are assembled as described above.

The present invention is further illustrated by the following figures, which show preferred embodiments of the invention and are not intended to limit the scope of the invention in any way, wherein:

FIG. 1 schematically shows an end of a cylindrical tubular element according to the invention, wherein said end comprises the frusto-conically shaped end section.

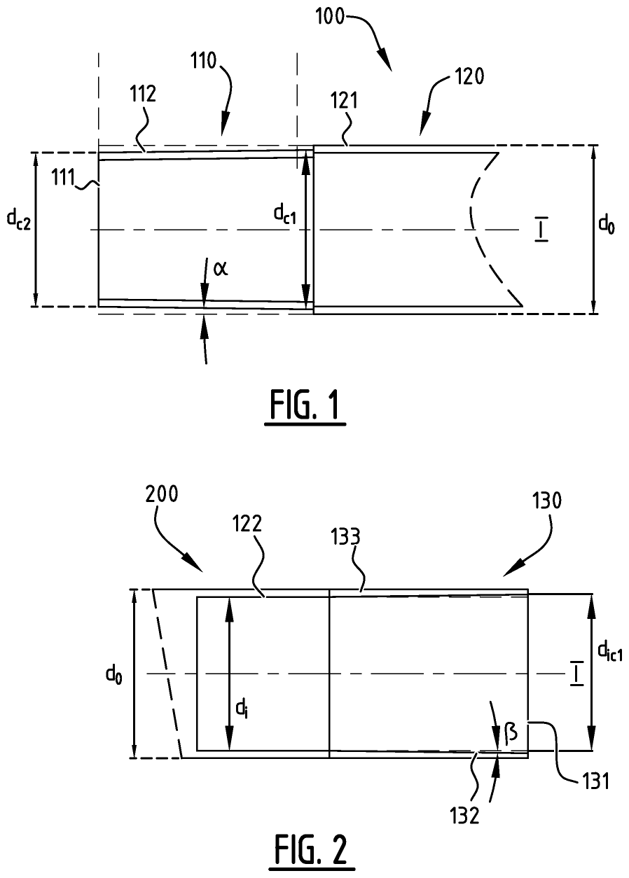

FIG. 2 schematically shows an end of a cylindrical tubular element according to the invention, wherein the respective end comprises the inverted inner frusto-conically shaped end section.

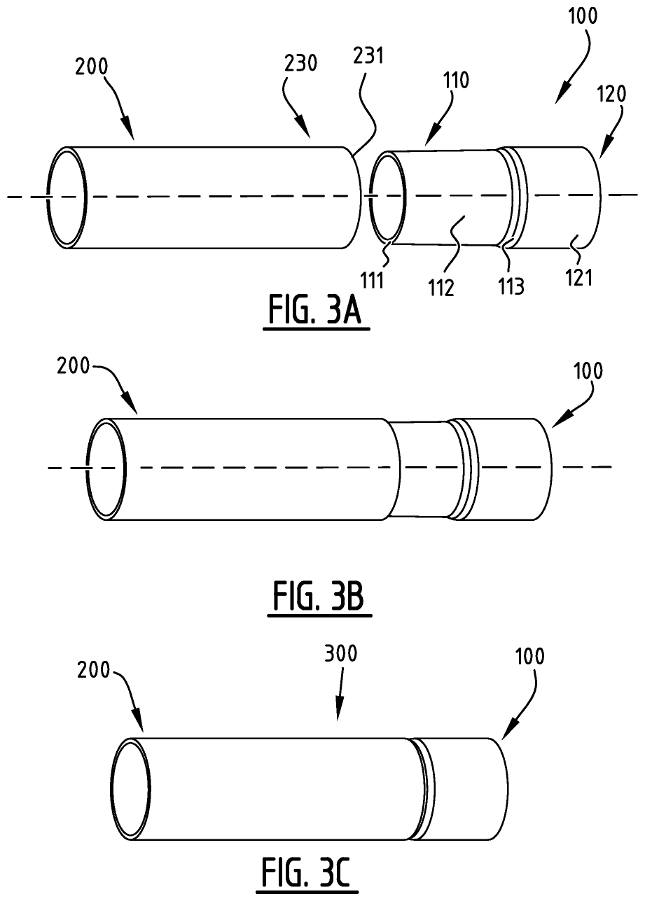

FIGS. 3A-3C schematically shows, in a series of step, the process of inserting the frusto-conically shaped end section of a first cylindrical tubular element into the inverted inner frusto-conically shaped end section of a second cylindrical tubular element.

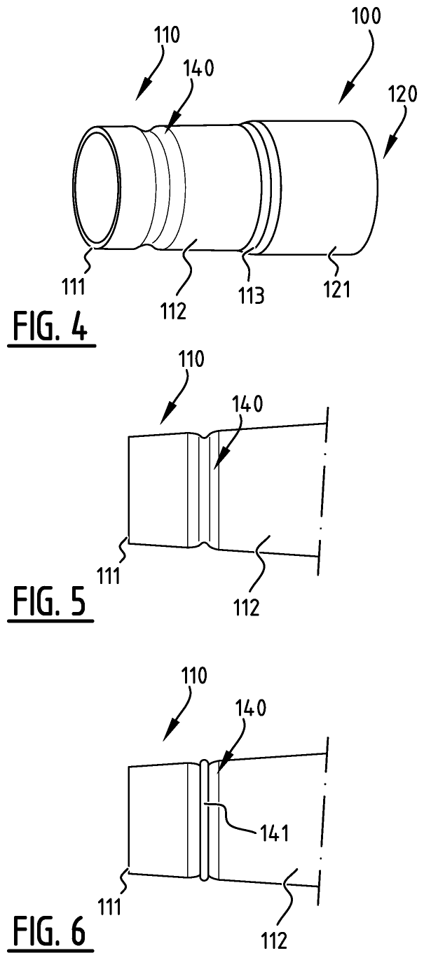

FIGS. 4-6 schematically illustrate a variant wherein the end section is provided with a gasket.

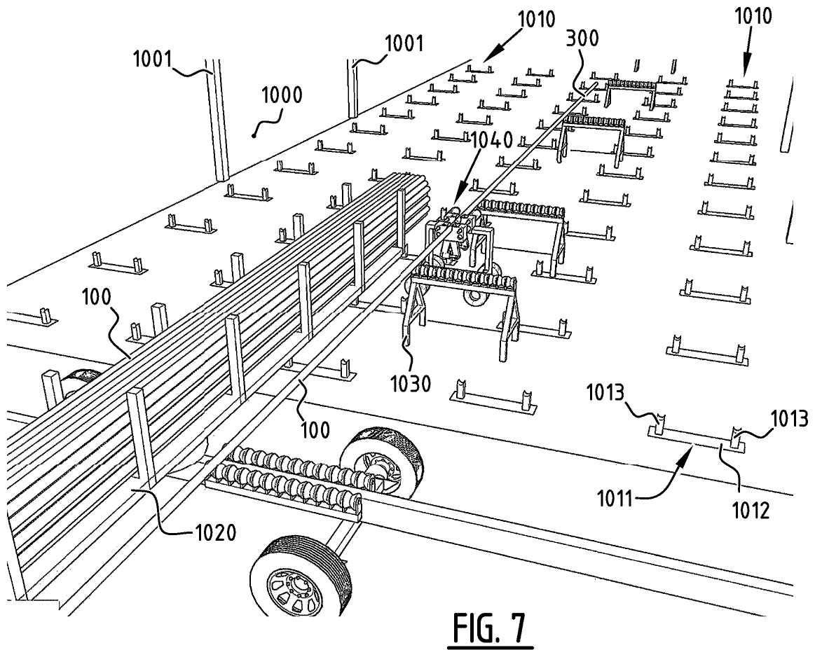

FIG. 7 schematically shows, in a still, an embodiment of the method of manufacturing a linear tube assembly for use in a plurality of spaced apart and parallel arranged longitudinal linear tubes that are to be arranged in a horticulture greenhouse.

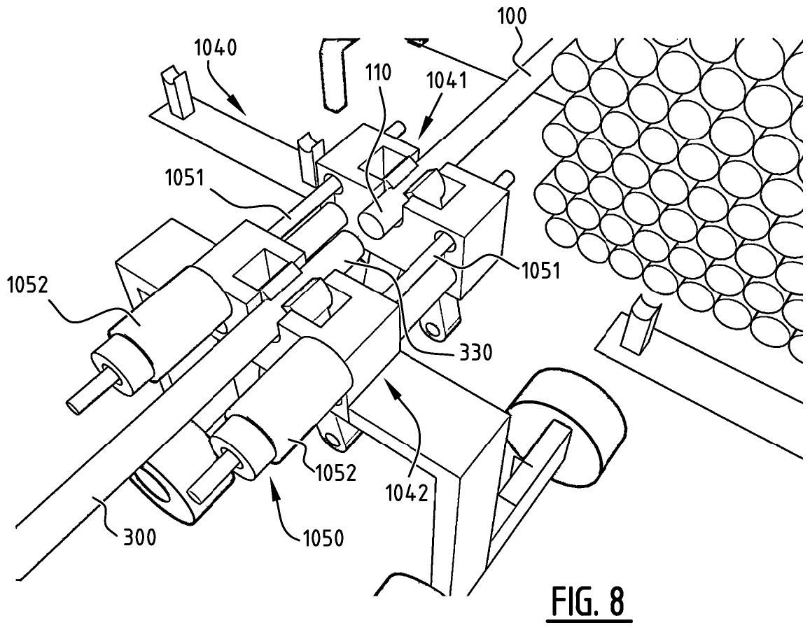

FIG. 8 schematically shows, in a zoomed in still, the step of pressing the frusto-conically shaped end section of a first cylindrical tubular element into the inverted inner frusto-conically shaped end section of a second cylindrical tubular element in the method shown in FIG. 7.

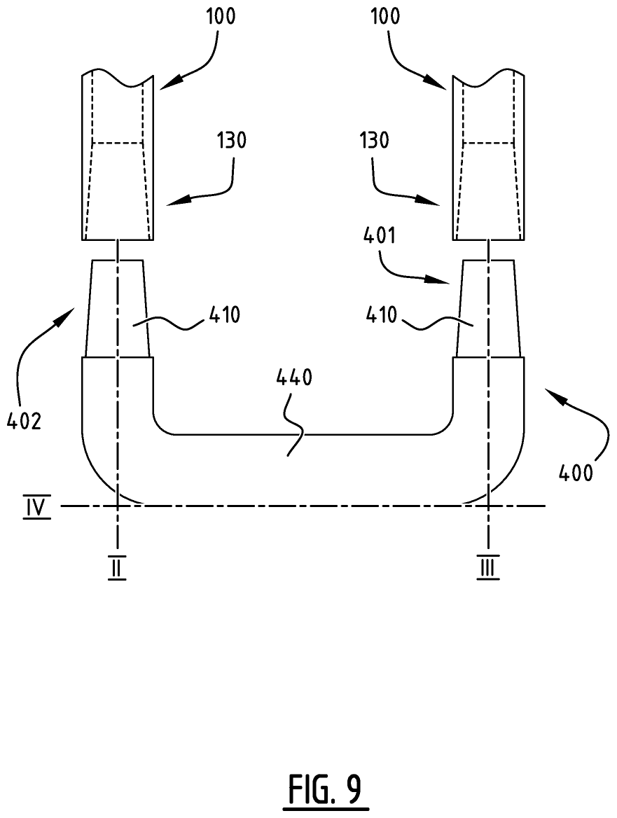

FIG. 9 schematically shows, in a top-view, a tubular coupling element for coupling a pair of cylindrical longitudinal linear tubes.

FIG. 1 schematically shows a first end of a cylindrical tubular element 100, wherein said end comprises the frusto-conically shaped end section 110, wherein, as seen along the central longitudinal axis I of the longitudinal cylindrical tubular element 100, an outer diameter of the frusto-conically shaped end section 110 decreases, from an initial diameter dc1, towards the first outer end 111 of the first longitudinal tubular element 100, to an outer diameter dc2. The decrease is, in the current example, a continuous linear decrease (i.e. having a constant rate of decrease) from the initial diameter dc1 to the distal outer diameter dc2. The decrease is, in the current example, such that an angle α, which is the angle between an outer surface 121 of the central section 120 (that is substantially parallel to the central longitudinal axis I) and the outer surface 112 of the frusto-conically shaped end section 110 is about 0.5-1 degrees (inwardly with respect to the central longitudinal axis I).

The decrease can, however, also be continuous and non-linear (i.e. having a non-constant rate of decrease), or can be non-continuous (i.e. wherein the frusto-conically shaped end section 110 comprises locally decreasing and locally increasing portions). In the current example, the outers surface 112 of the frusto-conically shaped end section 110 is a substantially smooth surface (i.e. having for instance no ridges, bumps, protrusions, recesses, threading and/or any locking means) in at least the longitudinal direction (i.e. parallel to central longitudinal axis I) of the outer surface 112.

The frusto-conically shaped end section 110 can be formed using a tube end reduction method, which is a process that reduces the outside diameter of the tubular element. Typically, two different processes that will create a reduced tube end are used. Firstly, ram forming and, secondly, segment, or finger segmented reduction.

The ram style of end forming is created by forcing a dedicated die over the end of the tubular element and then retracting the die back off the tubular element. The die is designed to achieve the proper outside diameter and length of the reduction and will only create the outer diameter that the die is designed for.

Segmented tube end forming involves a series of segmented fingers that close over the outer surface of the end section of the tubular element and, using a hydraulically powered process, to reduce the outer diameter of the end section of the tubular element. Even though this approach allows to obtain different outer diameters, the process, due to the segmented fingers, also leaves a series of longitudinally extending ribs in the outer surface of the frusto-conically shaped end section 110, which thus negatively affects the surface smoothness. These ribs, however, extend purely in the longitudinal direction, such that no radially extending unevenness's are present, still rendering the surface smooth enough for the purpose of mating with the inverted inner frusto-conically shaped end section 130. Any issues with respect to the water-tightness of the connection due to these ribs can, for instance, be addressed by applying a liquid gasket or adhesive.

The initial diameter dc1, at the start of the frusto-conically shaped end section 110, is reduced with respect to the outer diameter d0 of a central section 120 of the tubular element 100, such that a maximum outer diameter of the frusto-conically shaped end section 110, i.e. the initial diameter dc1, is smaller than the outer diameter d0. The central section 120 is a section of the tubular element 100 that is in between the respective outer ends of the longitudinal cylindrical tubular elements 100.

FIG. 2 schematically shows a second end of a cylindrical tubular element 100, wherein the respective second end comprises the inverted inner frusto-conically shaped end section 130. In the current example the longitudinal cylindrical tubular element 100 shown in FIG. 2 is the same longitudinal cylindrical tubular element 100 shown in FIG. 1, such that the second end shown in FIG. 2 is the opposite end, with respect to the frusto-conically shaped end section 110, of the tubular element 100. It may also be that, in other examples, the first end of FIG. 1 may be arranged on a first tubular element and the second end of FIG. 2 may be arranged on a second tubular element.

The second end section of the cylindrical longitudinal tubular element 100 is an inverted inner frusto-conically shaped end section 130, wherein, as seen along the central longitudinal axis I, an inner diameter of the frusto-conically shaped end section increases, from an initial inner diameter di, towards the second outer end 131 of the cylindrical longitudinal tubular element 100, to a distal inner diameter dic1. In the current example, the initial diameter di is equal to the inner diameter di of the cylindrical longitudinal tubular element 100. The outer diameter of the inverted inner frusto-conically shaped end section 130 is equal to the outer diameter d0 of the cylindrical longitudinal tubular element 100.

The increase in inner diameter is, in the current example, a continuous linear increase (i.e. having a constant rate of increase) from the initial inner diameter di to the distal inner diameter dic1 at the distal end of the inverted inner frusto-conically shaped end section 130. As described above for the frusto-conically shaped end section 110, continuously nonlinear or non-continuously are also possible. The increase is, in the current example, such that an angle β, which is the angle between an inner surface 122 of the central section 120 (that is substantially parallel to the central longitudinal axis I) and the inner surface 132 of the inverted inner frusto-conically shaped end section 130 is about 0.7 degrees (outwardly with respect to the central longitudinal axis I). The angles α and β are in magnitude substantially equal such that the outer shape of the frusto-conically shaped end section 110 is arranged to match the inner shape of the inverted inner frusto-conically shaped end section 130, for forming a reliable fixed connection upon inserting a frusto-conically shaped end section 110 into an inverted inner frusto-conically shaped end section 130 when coupling multiple cylindrical longitudinal tubular elements 100.

In the current example, the inner surface 132 of the inverted inner frusto-conically shaped end section 130 is a substantially smooth surface (i.e. having for instance no ridges, bumps, protrusions, recesses, threading and/or any locking means) in at least the longitudinal direction of the inner surface 132. The inverted inner frusto-conically shaped end section 130 is preferably manufactured by cutting away the excess material on the inside of the cylindrical longitudinal tubular element 100 using, for instance, a lathe or reaming device.

FIGS. 3A-3C schematically shows, in a series of step, the process of inserting the frusto-conically shaped end section 110 of a first cylindrical tubular element 100, i.e. for instance the longitudinal cylindrical tubular element 100 shown in FIGS. 1 and 2, into the inverted inner frusto-conically shaped end section 230 of a second cylindrical tubular element 200. The frusto-conically shaped end section 110 of a first cylindrical tubular element 100 faces the inverted inner frusto-conically shaped end section 230 of a second cylindrical tubular element 200. The respective central longitudinal axes I of the respective tubular elements 100, 200 are then aligned with each other. By moving the first cylindrical tubular element 100 towards the second 200 and/or vice versa, the frusto-conically shaped end section 110 moves into the inverted inner frusto-conically shaped end section 230.

At a certain point, the outer surface 112 of the frusto-conically shaped end section 110 and the inner surface 132 of the inverted inner frusto-conically shaped end section 130 come into contact and abut each other. By applying a predefined pressure in the direction of movement, the frusto-conically shaped end section 110 is moved further into the inverted inner frusto-conically shaped end section 130, such that they elastically deform thereby applying distributed normal forces onto each other. These distributed normal forces enable to obtain a large friction force, such that, once connected, the friction keeps the respective tubular elements 100, 200 connected to each other, thereby forming linear tube assembly 300. In addition, the obtained friction enables the connection to also handle external forces that are applied to the respective tubular elements 100, 200, caused by for instance internal water pressure of the heating and/or cooling liquid and the transversal forces and resulting bending moments caused by the wheels of trolleys moving over the linear tube assembly 300.

It is noted that a transitional section 113 is present between the central section 120 and the frusto-conically shaped end section 110, wherein the outer diameter is reduced from the outer diameter d0 of the central section 120 to the outer diameter dc1 at the start of the frusto-conically shaped end section 110. This transitional section 113 can be due to the production process for forming the frusto-conically shaped end section 110. For instance, the frusto-conically shaped end section 110 can be formed by first reducing the end section to a constant diameter dc1, after which a second reduction step is performed wherein the conical shaped is formed to obtain the above described shape.

Means for sealing the connection of the tubular elements 100, 200 may be arranged in between the end sections 110, 230 to enhance the liquid-tightness of the connection. Such an embodiment is schematically illustrated in FIGS. 4-6 wherein, with reference to for instance FIG. 3A, like elements are indicated by like reference signs. As shown in FIGS. 4-6, the outer surface 112 of the frusto-conically shaped end section 110 of the cylindrical tubular element 100 may be provided with a groove 140 extending circumferentially across the outer surface 112. An O-ring 141 is then seated in the groove 140 as shown in FIG. 6, such that the O-ring 141 is arranged in between the end sections 110, 230 once the tubular elements 100, 200 are connected.

FIG. 7 schematically shows the method of manufacturing a linear tube assembly for use in a plurality of spaced apart and parallel arranged longitudinal linear tubes that are to be arranged in a horticulture greenhouse. Within the greenhouse 1000 that comprises a number of columns 1001 for supporting the roof assembly of the greenhouse 1000, arrays 1010 of support members 1011 are shown, these support members 1011 comprise a bottom member 1012 and a pair of tube supports 1013 arranged for holding a cylindrical tubular member. Each of these arrays 1010 is to support a pair of linear tube assemblies 300, that are built up from a plurality of interconnected longitudinal cylindrical tubular elements 100. These longitudinal cylindrical tubular elements 100 are typically 6 to 10 meters long and having a 38, 45, 51, 57 or 63 mm outer diameter.

In this example, each of the longitudinal cylindrical tubular elements 100, i.e. tubes 100, situated in the storage rack 1020 is a longitudinal cylindrical tubular elements 100 as shown in FIGS. 1-3C. In the process of forming the linear tube assembly, a tube 100 are placed on roller supports 1030 and its outer end, being either the frusto-conically shaped end section 110 or inverted inner frusto-conically shaped end section 130 is moved along its longitudinal axis, over the roller supports 1030, to a pressing device 1040. The pressing device 1040 (shown in more detail in FIG. 8) comprises a first clamping unit 1041 for clamping the tube 100 and a second clamping unit 1042 for clamping the linear tube assembly 300 that is formed up to then. Note that this may also be another single tube 100 and not necessarily the linear tube assembly 300. First and second clamping units 1041, 1042 are moveable with respect to each other, such that they can be brought closer together using the driving mechanism 1050 comprising of at least one pull rod 1051 that is connect to the first clamping unit 1041 and at least one linear actuator 1052 arranged to move said first clamping unit 1041 by pulling said pull rod 1051.

The frusto-conically shaped end section 110 of the tube 100 faces the inverted inner frusto-conically shaped end section 330 of the linear tube assembly, as has also been described in relation to FIGS. 3A-3C. By pulling the first clamping unit 1041 towards the second clamping unit 1042, the respective end sections 110, 330 are connected to each other, as was described above. The force with which the tubes 100, 300 are pressed into each other can be predefined and set, such that a water-tight, mechanical interconnection is obtained for said tubes 100, 300. This process is repeated until the linear tube assembly obtains its desired length, after which it can be placed onto the support members 1011. This is repeated until all the arrays 1010 of supports are arranged with the linear tube assemblies 300, such that the plurality of spaced apart and parallel arranged longitudinal linear tubes is obtained. These can subsequently be used for the internal transport system using trolleys to ride over a pair of linear tube 300 assemblies forming a rails. Additionally, the plurality of spaced apart and parallel arranged longitudinal linear tubes can be connected to the temperature control system of the greenhouse 1000, such that a heating and/or cooling liquid runs through the plurality of spaced apart and parallel arranged longitudinal linear tubes that thereby effectively function as heat exchangers.

FIG. 9 schematically shows, in a top-view, a tubular coupling element 400 for coupling a pair of cylindrical longitudinal linear tubes 100. The cylindrical longitudinal linear tubes 100 are arranged such that the respective inverted inner frusto-conically shaped end sections 130 face correspondingly arranged frusto-conically shaped end sections 410 that are arranged at the first and section end sections 401, 402 of the tubular coupling element 400. The frusto-conically shaped end sections 410 are similarly to the frusto-conically shaped end sections 110 of the respective longitudinal linear tubes 100 as shown in previous figures.

The tubular coupling element 400 comprises at least an intermediate tubular section 440, that is arranged between the first and second end sections 401, 402, having a tangential IV thereto, wherein said tangential IV is at a non-zero angle with respect to the longitudinal axes II,III of the respective first or second end section. The pair of longitudinal linear tubes 100 are arranged in parallel and in the same order, i.e. both starting with an inverted inner frusto-conically shaped end section 130, the tubular coupling element 400 can thus easily connect to both ends 130 by having the same frusto-conically shape end sections 410 at both its ends 401, 402. The tubular coupling element 400 is, in the current example, a substantially U shaped tubular element, wherein the first and second end sections 401, 402 form the respective legs of the U, a perpendicular (i.e. perpendicular to the respective end sections 401, 402) intermediate tubular section 440 is arranged in between the respective legs of the U for forming the bottom section of said U. It is noted that, if said tubular coupling element 400 is to be arranged on the opposite end of the pair of longitudinal linear tubes 100, i.e. the end having the frusto-conically shaped end sections 110, a pair of inverted inner frusto-conically shaped end sections (not shown) can be arranged at the respective ends of the tubular coupling element 400. Alternatively, in case the pair of longitudinal linear tubes 100 is arranged in opposite directions, i.e. one having a frusto-conically shaped end sections 110 and one having an inverted inner frusto-conically shaped end sections 130, the coupling element 400 can be arranged such that it comprises, at a first end section 401, an inverted inner frusto-conically shaped end section (not shown) and at the other end a frusto-conically shaped end section 410.

The present invention is not limited to the embodiment shown, but extends also to other embodiments falling within the scope of the appended claims.

1. A system of tubular elements for use in a temperature control and/or transport system of a horticulture field or greenhouse that comprises a plurality of spaced apart and parallel arranged longitudinal linear tubes, wherein the system comprises at least two interconnected tubular elements,
wherein said first tubular element is connected at a first end section of the first longitudinal tubular element to the second tubular element at a second end section of the second tubular element;
wherein the respective first end section of the first tubular element is a frusto-conically shaped end section, wherein, as seen along a longitudinal axis of the first end section, an outer diameter of the frusto-conically shaped end section decreases towards the first outer end of the first tubular element;
wherein the respective second end section of the second tubular element is an inverted inner frusto-conically shaped end section, wherein, as seen along a longitudinal axis of the respective second end section, an inner diameter of the frusto-conically shaped end section increases towards the second outer end of the second tubular element;
wherein said inverted inner frusto-conically shaped end section of said second tubular element is arranged to receive the frusto-conically shaped end section of the first tubular element for forming a connection section, such that the first and second tubular elements are mechanically interconnected at the connection section by insertion of the frusto-conically shaped end section of a first tubular element into the inverted inner frusto-conically shaped end section of the second tubular element,
wherein at least one longitudinal linear tube of the plurality of spaced apart and parallel arranged longitudinal linear tubes comprises said respective first and second tubular elements, wherein said first and second tubular elements are longitudinal tubular elements having a respective central longitudinal axes that coincided and align with the respective longitudinal axes of the respective end sections, such that the respective central longitudinal axes of the first and second tubular elements align and coincide for, at least partly, forming said at least one longitudinal linear tube, wherein, at the start of the frusto-conically shaped end section, the outer diameter is reduced such that a maximum outer diameter of the frusto-conically shaped end section is smaller than the outer diameter of a central section of the tubular element, wherein said central section is in between the first end section and the opposite second end section of the tubular elements, wherein said at least one longitudinal linear tube has a substantially constant outer diameter over substantially the full length of the respective longitudinal linear tube.

2. A system of tubular elements according to claim 1, wherein at least one of said first and second tubular element is a tubular coupling element, wherein said tubular coupling element interconnects at least two spaced apart longitudinal linear tubes of the plurality of spaced apart longitudinal linear tubes, wherein said tubular coupling element comprises at least an intermediate tubular section, that is arranged in between the first and second end sections, having a tangential thereto, wherein said tangential is at a non-zero angle with respect to the longitudinal axes of the respective first or second end section.

3. A system of tubular elements according to claim 1, wherein said system of assembled tubular elements is arranged for guiding a flow of heating and/or cooling liquid therethrough and is arranged as a heat transfer element for transferring energy from the heating and/or cooling liquid to an internal environment of said horticulture greenhouse and/or vice versa; and wherein said connection section forms a liquid-tight connection.

4. A system of tubular elements according to claim 1, wherein a gasket is arranged in between said frusto-conically shaped end section and inverted inner frusto-conically shaped end section.

5. A system of tubular elements according to claim 4, wherein the gasket is an O-ring seated in a groove provided circumferentially in the outer surface of the frusto-conically shaped end section.

6. A system of tubular elements according to claim 1, wherein at least one longitudinal linear tube of the plurality of spaced apart and parallel arranged longitudinal linear tubes forms part of a rail system of the respective transport system for supporting a trolley.

7. A system of tubular elements according to claim 6, wherein the at least one longitudinal linear tube of the plurality of spaced apart and parallel arranged longitudinal linear tubes is suspended in the greenhouse and arranged for supporting a monorail-vehicle that can suspended from, and arranged underneath, the at least one longitudinal linear tube, such that said monorail-vehicle is movable along the at least one longitudinal linear tube; or
wherein said rail system of the respective transport system comprises two spaced apart longitudinal linear tubes of the plurality of spaced apart and parallel arranged longitudinal linear tubes that are supported at a predefined height with respect to a ground surface, such that a rail-vehicle can be movable supported by the two spaced apart longitudinal linear tubes.

8. (canceled)

9. A system of tubular elements according to claim 1, wherein an outer diameter of the inverted inner frusto-conically shaped end section is substantially equal to the outer diameter of the central section of the second tubular element.

10. A system of tubular elements according to a claim 1, wherein said first tubular element comprises, at a second end section that is arranged at the opposite end of the first tubular element, an inverted inner frusto-conically shaped end section, wherein, as seen along a longitudinal axis second end section of the first tubular element, an inner diameter of the frusto-conically shaped end section increases towards the second outer end of the first longitudinal tubular element; and/or
wherein said second tubular element comprises, at a first end section that is arranged at the opposite end of the second tubular element, a frusto-conically shaped end section, wherein, as seen along a longitudinal axis at the first end section of the second tubular element, an outer diameter of the frusto-conically shaped end section decreased towards the first outer end of the second tubular element.

11. A system of tubular elements according to claim 1, wherein said frusto-conically shaped end section has a substantially smooth outer surface and/or said inverted inner frusto-conically shaped end section has a substantially smooth inner surface.

12. A system of tubular elements according to claim 1, wherein said tubular elements are mechanically interconnected by a slip-critical joint, wherein at least part of an outer surface of the frusto-conically shaped end section and at least part of an inner surface of the inverted inner frusto-conically shaped end section are arranged as faying surfaces that abut each other, and
wherein said faying surfaces are abutting and coupled to each other through friction after pressing said frusto-conically shaped end section into said inverted inner frusto-conically shaped end section with a predetermined pressing force upon interconnecting said tubular elements.

13. A system of tubular elements according to claim 1, wherein the outer diameter of the frusto-conically shaped end section continuously decreases towards the first outer end of the first tubular element; and/or
wherein the inner diameter of the frusto-conically shaped end section continuously increases towards the second outer end of the second tubular element.

14. A system of tubular elements according to claim 1, wherein the outer diameter of the frusto-conically shaped end section comprises decreases with an angle of 0.01 degrees-5 degrees, preferably 0.1 degrees-2.5 degrees, more preferably 0.25 degrees-1.5 degree, most preferably 0.5-1 degrees; and
wherein the inner diameter of the inverted inner frusto-conically shaped end section increases with angle of 0.01 degrees-5 degrees, preferably 0.1 degrees-2.5 degrees, more preferably 0.25 degrees-1.5 degree, most preferably 0.5-1 degrees; and
wherein a ratio between the angle of decrease of the frusto-conically shaped end section and the angle of increase of the inverted inner frusto-conically shaped end section is between 0.5 and 2, preferably between 0.75 and 1.5, more preferably between 0.9 and 1.1 and most preferably around 1.

15. A system of tubular elements according to claim 1, wherein a length of the frusto-conically shaped end section is in the range of 0.25-3 times, preferably in the range of at least 0.35 times-2 times, more preferably in the range of 0.5-1.5 times, an outer diameter of the first tubular element; and
wherein a length of the inverted inner frusto-conically shaped end section is in the range of 0.25-3 times, preferably in the range of at least 0.35 times-2 times, more preferably in the range of 0.5-1.5 times, an outer diameter of the first tubular element; and
wherein a ratio between the length of the frusto-conically shaped end section and the length of the inverted inner frusto-conically shaped end section is between 0.5 and 2, preferably between 0.75 and 1.5, more preferably between 0.9 and 1.1 and most preferably around 1.

16. A system of tubular elements according to claim 1, wherein said first and second tubular elements are longitudinal steel tubes.

17. (canceled)

18. (canceled)

19. A temperature control and/or transport system for use in a horticulture field or greenhouse comprising a system of tubular elements according to claim 1.

20. A horticulture greenhouse comprising the temperature control and/or transport system according to claim 19.

21. A cylindrical tubular element for use in system of tubular elements according to claim 1, wherein the cylindrical tubular element comprises a first end section and an opposite second end section;
wherein said first end section is a frusto-conically shaped end section, wherein, as seen along a longitudinal axis of the first end section, an outer diameter of the frusto-conically shaped end section decreases towards the first outer end of the tubular element, wherein, at the start of the frusto-conically shaped end section, the outer diameter is reduced such that a maximum outer diameter of the frusto-conically shaped end section is smaller than the outer diameter of a central section of the cylindrical tubular element, wherein said central section is in between the first end section and the opposite second end section of the tubular elements; and
wherein said opposite second end is an inverted inner frusto-conically shaped end section, wherein, as seen along the longitudinal axis of the tubular element, an inner diameter of the frusto-conically shaped end section increases towards the second outer end of the tubular element;
wherein an outer diameter of the inverted inner frusto-conically shaped end section is substantially equal to the outer diameter of the central section of the cylindrical tubular element.

22. The cylindrical tubular element according to claim 21, wherein said inverted inner frusto-conically shaped end section is arranged to receive the frusto-conically shaped end section, such that a plurality of equally shaped longitudinal tubular elements can be mechanically interconnected by inserting a frusto-conically shaped end section of a first tubular element into an inverted inner frusto-conically shaped end section of a second tubular element of said plurality of equally shaped longitudinal tubular elements; or
wherein said tubular coupling element is arranged to interconnect at least two spaced apart longitudinal linear tubes of the plurality of spaced apart longitudinal linear tubes as used in the system of assembled tubular elements, wherein said tubular coupling element comprises at least an intermediate tubular section, that is arranged between the first and second end sections, having a tangential thereto, wherein said tangential is at a non-zero angle with respect to the longitudinal axes of the respective first or second end section, and wherein said first and second end sections are both frusto-conically shaped end sections or are both inverted inner frusto-conically shaped end sections.

23. (canceled)

24. (canceled)

25. A method of manufacturing a system of assembled tubular elements according to claim 1, comprising the steps of:
providing a first tubular element having a respective first end section that is a frusto-conically shaped end section, wherein, as seen along the longitudinal axis of the first end section of the first tubular element, an outer diameter of the frusto-conically shaped end section decreases towards the first outer end of the first tubular element;
providing a second tubular element having a respective second end section that is an inverted inner frusto-conically shaped end section, wherein, as seen along the longitudinal axis of the second end section of said second tubular element, an inner diameter of the frusto-conically shaped end section increases towards the second outer end of the second tubular element;
aligning said first and second tubular elements such that respective longitudinal axes of the respective first and second end sections element align and coincide and such that the respective first end section of the first tubular element faces the respective second end section of the second tubular element;
inserting the frusto-conically shaped end section of the first tubular element into the inverted inner frusto-conically shaped end section of the second tubular element;
pressing said frusto-conically shaped end section into said inverted inner frusto-conically shaped end section by pressing said first and second tubular elements towards each other along the respective longitudinal axes with a predefined pressing force, such that the frusto-conically shaped end section of the first tubular element is forced into the inverted inner frusto-conically shaped end section of the second tubular element for mechanically interconnection said tubular elements.

26. (canceled)
